(19) United States
(12) Patent Application Publication
(10) Pub. No.: US 2007/0012205 A1
(43) Pub. Date: Jan. 18, 2007

(54) Printing machine and corresponding method

(75) Inventors: Antoine Chevalier, Gouvieux (FR); Bernard Beranger, Gouvieux (FR); Pascal Ollivier, Verneuil En Halatte (FR); Alain Blanchard, Gouvieux (FR); Roger Stanchina, Chantilly (FR)

Correspondence Address: DAVIDSON, DAVIDSON & KAPPEL, LLC, 485 SEVENTH AVENUE, 14TH FLOOR, NEW YORK, NY, 10018, US

(73) Assignee: GOSS INTERNATIONAL MONTATAIRE SA, Montataire (FR)

(21) Appl. No.: 11/488,327

(22) Filed: Jul. 18, 2006

(30) Foreign Application Priority Data
Jul. 18, 2005 (FR) 05 07619

(51) Int. Cl. B41F 13/56

(52) U.S. Cl. 101/226

(57) ABSTRACT

A rotary printing machine is provided which includes at least one printing unit suitable for printing on a continuous printing web of material to be printed and a cutting device which is suitable for cutting the web printed by the printing unit. The rotary printing machine further includes a traction device which is located downstream of the printing unit that is furthest downstream, and upstream of the cutting device. The traction device is suitable for applying a predetermined mechanical tension to the printed web being discharged from the printing unit that is furthest downstream.

### FIELD OF THE INVENTION

The present invention relates to a rotary printing machine, of the type including at least one printing unit which is suitable for printing on a continuous printing web of material to be printed, and a cutting device which is suitable for cutting the web printed by the printing unit.

### BACKGROUND OF THE INVENTION

Rotary printing machines are known from the prior art and include at least one printing unit which is provided with a pair of printing rollers, and a cutting device which is suitable for cutting the web printed by the printing unit.

Known printing machines further include a dryer which is arranged between the last printing unit and the cutting device. This dryer is used to dry the ink which is deposited on the printed web in order to prevent the sheets from becoming marked in the cutting device.

### BRIEF SUMMARY OF THE INVENTION

The presence of a dryer leads to the printing machine having a large spatial requirement and increases the cost of the printing machine.

An object of the present invention is to overcome these disadvantages and to provide a printing machine which has a smaller spatial requirement.

To this end, the present invention provides a traction device which is located downstream of the printing unit that is furthest downstream, and upstream of the cutting device, and in that the traction device is suitable for applying a predetermined mechanical tension to the printed web being discharged from the printing unit that is furthest downstream.

The invention further relates to a printing method of the type including the steps of:

printing on a printing web, with a printed web being formed;

cutting the printed web into printed sheets; and

producing a predetermined mechanical tension in the printed web before cutting using a printing machine as defined above.

### BRIEF DESCRIPTION OF THE DRAWINGS

The invention will be better understood from a reading of the following description, given purely by way of example and with reference to the appended drawings, in which:

FIG. 1 is a schematic side view of a printing machine according to the invention;

FIG. 2 is a view corresponding to the view of FIG. 1 of a variant of a printing machine according to the invention;

FIG. 3 is a perspective view of a detail of a traction device according to a first embodiment of the invention;

FIGS. 4 and 5 are detailed views, corresponding to the view of FIG. 3, of second and third embodiments of a traction device according to the invention;

FIGS. 6 and 7 are side views of fourth and fifth embodiments of a traction module according to the invention;

FIGS. 8A to 8C are side views of a detail of a traction module according to a sixth embodiment of the invention, during various operating steps;

FIG. 9 is a sectioned view of a traction roller of a traction module according to a seventh embodiment of the invention;

FIG. 10 is a schematic side view of a detail of a traction module according to an eighth embodiment;

FIG. 11 is a plan view of the detail of FIG. 10;

FIG. 12 is a schematic side view of a printing machine according to a second variant, comprising an accompaniment device for the printed web; and

FIGS. 13 and 14 are side views of the first and second embodiments of the accompaniment device.

### DESCRIPTION OF THE PREFERRED EMBODIMENTS

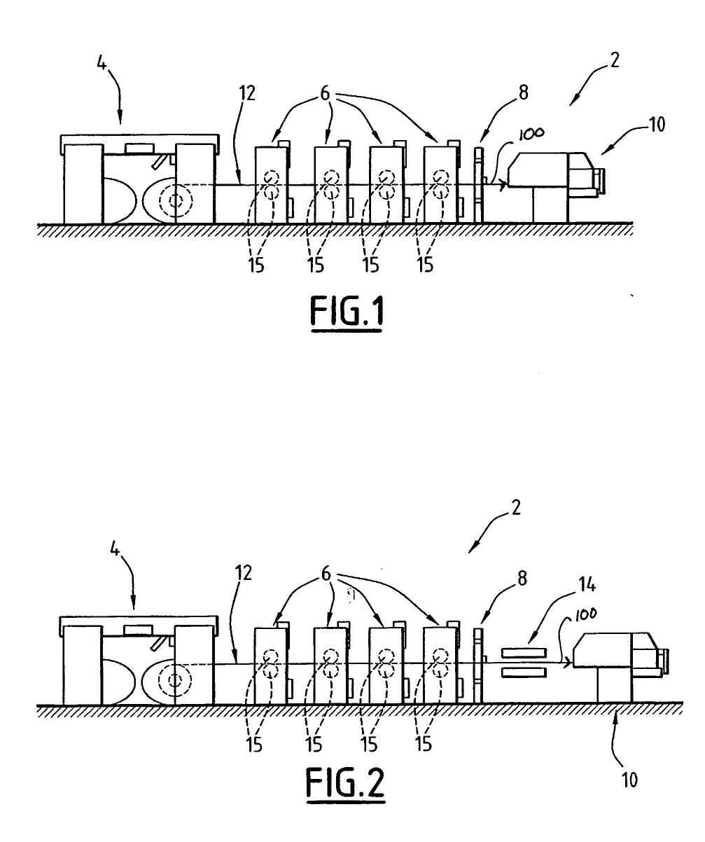

FIG. 1 illustrates a rotary printing machine according to the invention, generally designated 2.

The printing machine 2 includes an unwinding device 4, four printing units 6, a traction device 8 and a cutting device 10. The printing machine 2 could include any number of printing units 6, in theory, from one to n.

The unwinding device 4 is suitable for unwinding a continuous web 12 to be printed.

The printing machine 2 defines a printing path 100 for the web 12 between the unwinding device 4, via the printing units 6 and the traction device 8, as far as the cutting device 10.

The printing units 6 include printing rollers 15 which are suitable for printing on the web 12.

The cutting device 10 is suitable for cutting the web 12 to be printed into individual sheets.

The traction device 8 is located downstream of the printing unit 6 that is furthest downstream, and upstream of the cutting device 10. This traction device 8 is suitable for applying a predetermined mechanical tension to the web 12 which is being discharged from the printing unit 6 that is furthest downstream.

As can be seen in FIG. 1, the printing machine 2 can convey the printed web 12 in a state of free suspension and in ambient air over the entire path 100 between the printing unit 6 that is furthest downstream and the traction device 8. Furthermore, the printing machine 2 is also suitable for conveying the printed web 12 in ambient air over the entire path between the traction device 8 and the cutting device 10. In this manner, the printing machine 2 does not include a dryer and has a small spatial requirement.

The printing machine 2 according to the variant illustrated in FIG. 2 differs from the printing machine 2 illustrated in FIG. 1 owing to the fact that there is arranged, between the traction device 8 and the cutting device 10, an infrared radiation dryer 14 through which the printed web 12 is conveyed. The dryer 14 has smaller dimensions than the dryers of the prior art.

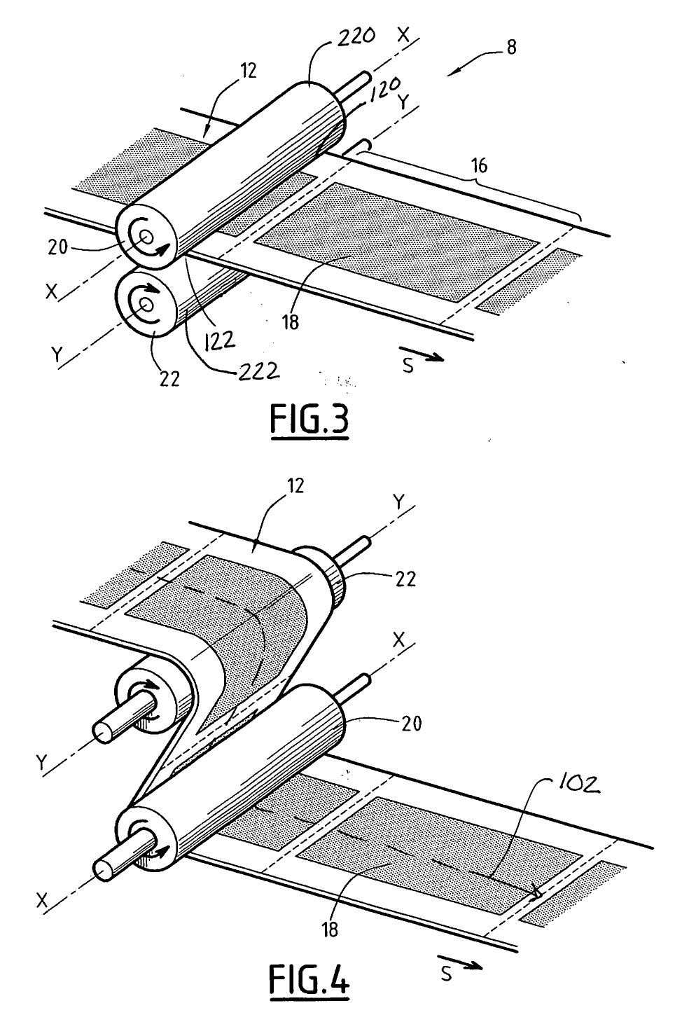

FIG. 3 is a perspective view of a detail of the traction device 8 according to the invention. The printed web 12 can be seen. The printed web 12 is constituted by a series of web portions 16, each of which has the length of a sheet cut by the cutting device 10. Each portion 16 further comprises an image 18 which is printed on both sides by the printing rollers of the printing units 6. Furthermore, each portion 16 comprises a non-printed zone which does not comprise any ink.

The traction device 8 comprises two traction rollers 20, 22 which are driven in rotation about their respective axes X-X, Y-Y. Each of the traction rollers 20, 22 comes into contact with one of the surfaces of the printed web 12. The traction rollers 20, 22 are driven in opposing directions, and their traction surface 120, 122 moves, at the location of contact with the web 12, in the same direction S as the printed web 12. Each of the traction rollers 20, 22 has an outer surface 220, 222 whose circumference is identical to the length of the web portion 16, which reduces marking. In a variant, the circumference is identical to an integer multiple of the length of the portion 16.

The outer surface 220, 222 of each traction roller 20, 22 is produced from a material which repels the ink used in order to print the images 18. The traction rollers 20, 22 comprise, for example, a hydrophilic surface. One of the two rollers is coated with an elastomer. The contact generating line of the two rollers brings about a pinching effect in order to pull the web 12 of paper. The surfaces of the two traction rollers 20, 22 may, for example, comprise a coating of a silicone-based compound.

The two traction rollers 20, 22 are arranged facing each other so that the contact line of the traction roller 20 with the web 12 and the contact line of the traction roller 22 with the web 12 are located facing each other.

Advantageously, the circumferential speed of the traction rollers 20, 22 is slightly greater than the circumferential speed of the printing rollers of the printing unit 6 that is furthest downstream, so that the printed web 12 is maintained in a state of traction and therefore predetermined mechanical tension between the printing unit 6 and the traction device 8.

The traction device 8 allows a web of paper to be printed and received in a cutting device 10, such as a flat-type output, without drying this web of paper by evaporating the solvents of the ink.

Furthermore, the image 18 is advantageously printed using a fast-drying ink, waterless inks or bicomponent inks. The drying of fast-drying inks is the combination of a first phenomenon referred to as “penetration in the support” and a second phenomenon referred to as “oxide-polymerization of the lacquers constituted by oils and resins”. Inks which can be fixed by means of heat (“heat-set”) dry by means of evaporation of the mineral solvents which are mixed with the resin. UV inks dry by means of polymerization of the resin under the effect of ultra-violet radiation.

Waterless inks are used with specific printing plates which allow non-printing zones to be defined without using a conventional lithographic method which is based on the rejection of printing ink by a hydrophilic surface which has been dampened beforehand. The use of these inks facilitates or prevents rapid drying and allows a dryer to be dispensed with or designed so as to take up less space.

FIG. 4 illustrates a detail of a second embodiment of a traction device 8 which differs from FIG. 3 in the following manner.

Elements which are similar have the same reference numerals.

The two traction rollers 20, 22 are arranged with mutual spacing so that they define a substantially S-shaped path 102 for the printed web 12. The S-shaped arrangement allows the rolling arc of the web to be increased on the driven rollers and therefore allows the efficiency of the traction module to be promoted owing to a capstan effect. Another device will then have to be associated with this traction module. This device will have to allow a level of downstream tension to be produced which is low but which is sufficient to bring about a level of upstream tension which is sufficiently high to pull the web out of the last printing assembly.

FIG. 5 illustrates a detail of a third embodiment of a traction device 8 according to the invention which differs from the embodiment of FIG. 3 in the following manner. Similar elements have the same reference numerals.

The traction module 8 further includes two cleaning devices 30, 32. The quality of the image 18 on the printed web 12 is thus further improved.

The cleaning devices 30, 32 include cleaning bars 34, 36 which are in permanent contact with the traction surface 120, 122 of the rollers 20, 22. By way of example, the cleaning bars 34, 36 may include a rotating brush which is placed in contact with the surface to be cleaned or a web of materials placed in contact by means of a mechanical element. In both cases, the cleaning is facilitated by the action of a solvent. These techniques are used in particular for washing blankets on rotary offset presses.

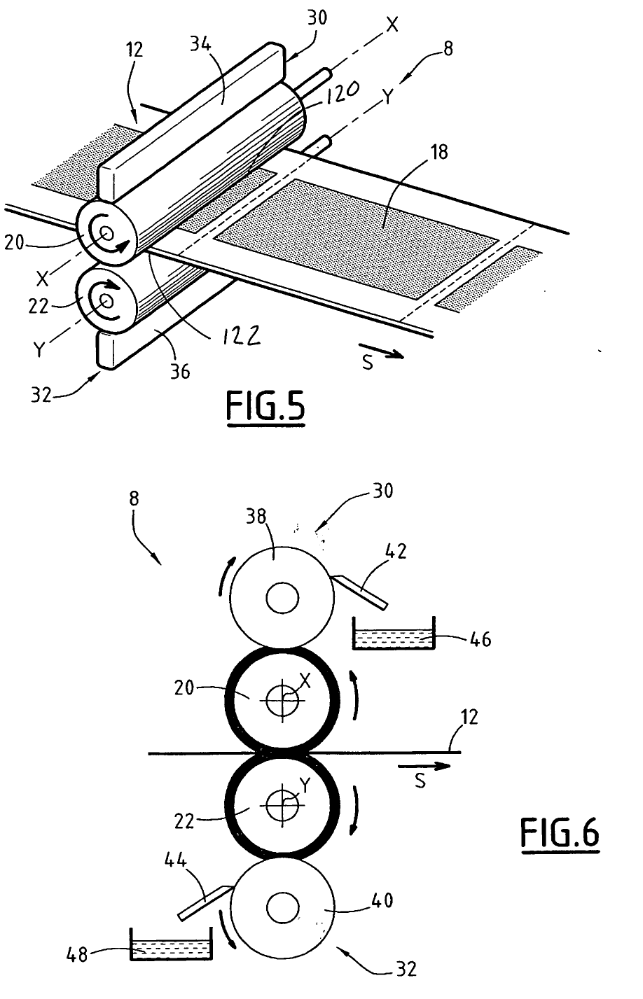

FIG. 6 is a side view of a fourth embodiment of the traction device 8. This embodiment differs from the third embodiment in the following manner.

The two traction rollers 20, 22 include surfaces which repel ink, such as a coating of a silicone-based compound.

The cleaning device 30 includes a cleaning roller 38 which includes a surface of a material which attracts ink and which is in contact with the surface of the traction roller 20. The cleaning roller 38 is, for example, coated with a porous ceramic material which is intended to be impregnated with ink and which thus has surface properties which promote the transfer of ink. This technique is used in particular to produce ink duct rollers. The cleaning device 30 further comprises a scraper 42 which is in permanent contact with the surface of the cleaning roller 38 and which conveys the ink removed by the roller 38 to a recovery vessel 46.

The cleaning device 32 further includes a cleaning roller 40 which includes a surface of a material which attracts ink, such as a coating of a porous ceramic material which is intended to be impregnated with ink and which thus has surface properties which promote the transfer of ink. The surface of the roller 40 is in contact with the surface of the traction roller 22. The cleaning device 32 further comprises a scraper 44 which is in permanent contact with the surface of the cleaning roller 40 and which conveys the ink removed by the rollers 40 to a recovery vessel 48.

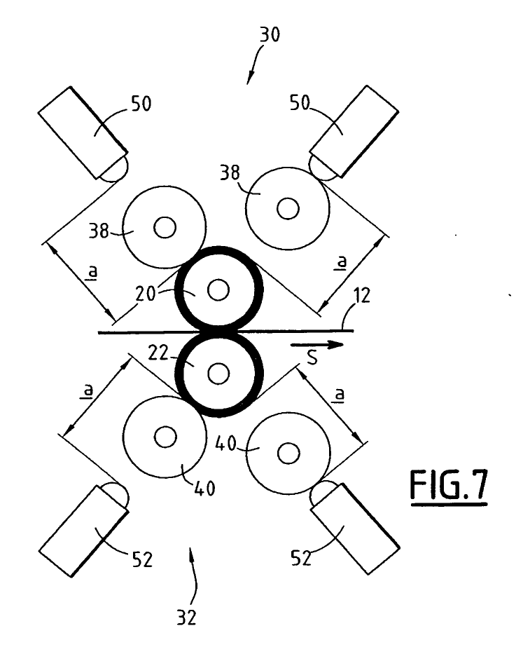

FIG. 7 illustrates a fifth embodiment of the traction device 8 which comprises a variant of the cleaning devices 30, 32. Each cleaning device 30, 32 comprises two cleaning rollers 38, 40 which attract the ink and, for each of the cleaning rollers 38, 40, a washing device 50, 52.

The washing device 50, 52 is arranged at a distance a from the surface of the associated traction roller 20, 22 greater than the diameter of the corresponding cleaning roller 38, 40. Each cleaning roller 38, 40 can be moved between a cleaning position in which it is in contact with the associated traction roller 20, 22 and a washing position in which it is in contact with the associated washing device 50, 52. The two cleaning rollers 38, 40 of each cleaning device 30, 32 are controlled so as to alternately come into contact with the associated traction roller 20, 22.

That is to say, whilst one of the cleaning rollers 38 is in contact with the traction roller 20, the other cleaning roller 38 is in contact with the washing device 50. In the same manner, whilst one of the cleaning rollers 40 is in contact with the traction roller 22, the other cleaning roller 40 is in contact with the washing device 52. The device described in FIG. 7 has an advantage compared with the device described in FIG. 6. Assuming that the cleaning operation may, owing to contamination by the washing solvent, temporarily change the properties of the surfaces of the rollers 20 and 22 (rejection of the ink), this operation is carried out, in the case of the device of FIG. 7, on rollers 38 and 40 which are not in contact with the traction rollers 20 and 22.

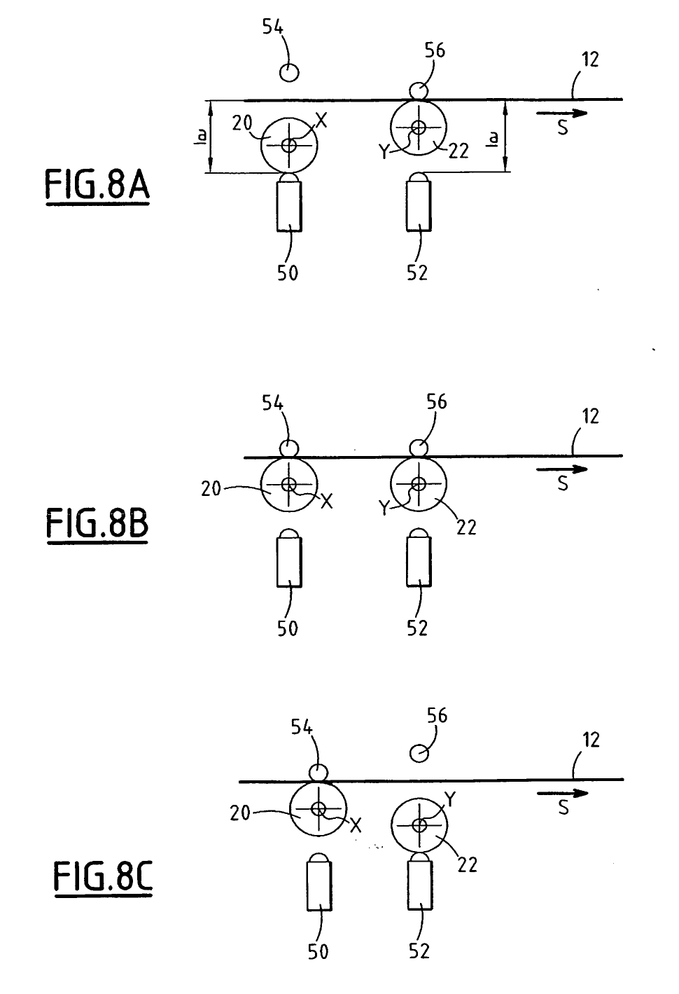

FIGS. 8A to 8C illustrate a sixth embodiment of a traction module 8 according to the invention.

This traction device includes two traction rollers 20, 22 which are arranged one behind the other at one side of the printed web 12 only. The traction device 8 further includes two clamping rollers 54, 56 which are arranged at the other side of the web 12 to be printed and which have a diameter smaller than the diameter of the traction rollers 20, 22. Each of the clamping rollers 54, 56 is suitable for pressing on the printed web 12.

Each clamping roller 54, 56, in conjunction with the associated traction roller 20, 22, is suitable for clamping the printed web 12.

The traction rollers 20, 22 are suitable for coming into contact alternately with the printed web 12.

The traction device further includes, for each traction roller 20, 22, a washing device 50, 52. Each washing device 50, 52 is located at a distance a from the surface of the printed web 12 greater than the diameter of the associated traction roller 20, 22. When the traction roller 20, 22 is not in contact with the printed web 12, these washing devices 50, 52 wash the surface of the traction roller 20, 22.

FIG. 8A illustrates the step in which the traction roller 20 is in the process of being cleaned by the washing device 50. The clamping roller 54 is remote from the surface of the web 12. The traction roller 22 is remote from the washing device 52 and is pressed onto the surface of the printed web 12. The clamping roller 56 also presses on the web 12 so that the web 12 is clamped between the clamping roller 56 and the traction roller 22.

FIG. 8B illustrates an intermediate step, following the end of cleaning of the traction roller 20. During this step, the two traction rollers 20, 22 are in contact with the web 12 and the clamping rollers 54, 56 also press on the web.

During a subsequent step, illustrated in FIG. 8C, only the traction roller 20 and the clamping roller 54 clamp the web 12 between them, whilst the traction roller 22 and the clamping roller 56 are not in contact with the web 12, the traction roller 22 being cleaned by the cleaning device 52.

The device described in FIGS. 8A, 8B, 8C has an advantage compared with the device described in FIG. 6. Assuming that the cleaning operation may, owing to contamination by the cleaning solvent, temporarily change the properties of the surfaces of the rollers 20 and 22 (rejection of the ink), this operation is carried out using the cleaning devices 50 and 52 whilst the traction rollers 20 and 22 are not in contact with the web.

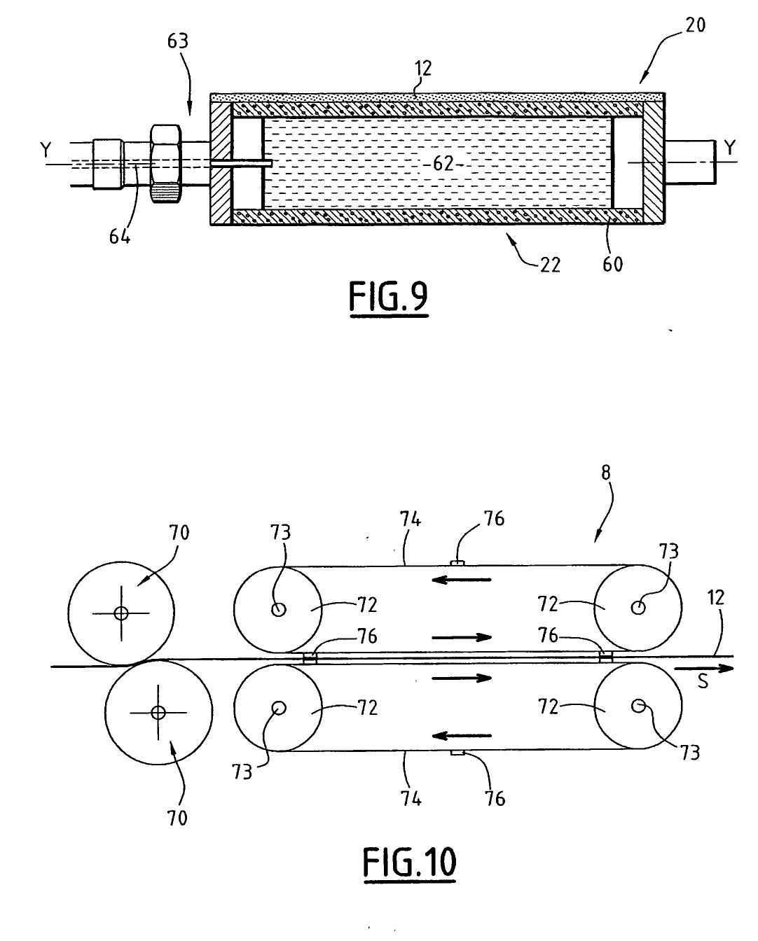

FIG. 9 is a cross-section of a traction roller of a seventh embodiment of a traction module 8 according to the invention. This traction module 8 includes a traction roller 22 which is provided with a porous wall 60 so as to define a porous traction surface. The pores of the wall 60 are open cells so that a liquid 62 which is arranged at the inner side of the roller 22 can pass through the wall 60 and come into contact with the printed web 12. The liquid 62 is, for example, a mixture of water and silicone.

Furthermore, the traction roller 22 also includes a rotary joint 63 which includes a central liquid supply 64 which opens at the inner side of the traction roller 22. The supply 64 is arranged in a coaxial manner relative to the axis Y-Y of the traction roller 22.

FIGS. 10 and 11 illustrate an eighth embodiment of a traction device 8 according to the invention.

This traction device 8 includes two blanket rollers 70 which press at both sides on the printed web 12 and which are offset relative to each other in the direction of the path 100 of the web 12.

The traction device 8 further includes eight toothed rollers 72 which are connected in pairs by means of a shaft 73. The traction device 8 is provided with four belts or chains 74, each of which is guided around two toothed rollers 72 which are arranged at one side of the web 12. The two belts 74 at one side of the printed web 12 are connected by means of traction bars 76 which are arranged on the belt 74 at a mutual distance which corresponds to the length of the web portion 16. The traction bars 76 are suitable for pressing on the web 12 at both sides, facing each other, and clamping the web between them. They are thus suitable for applying traction to the web 12.

The bars 76 are preferably driven in a synchronous manner with the web 12 so that they press only on the non-printed zone of the web 12. Furthermore, the surface which comes into contact with the web 12 of the bar 76 is preferably of elastomer material.

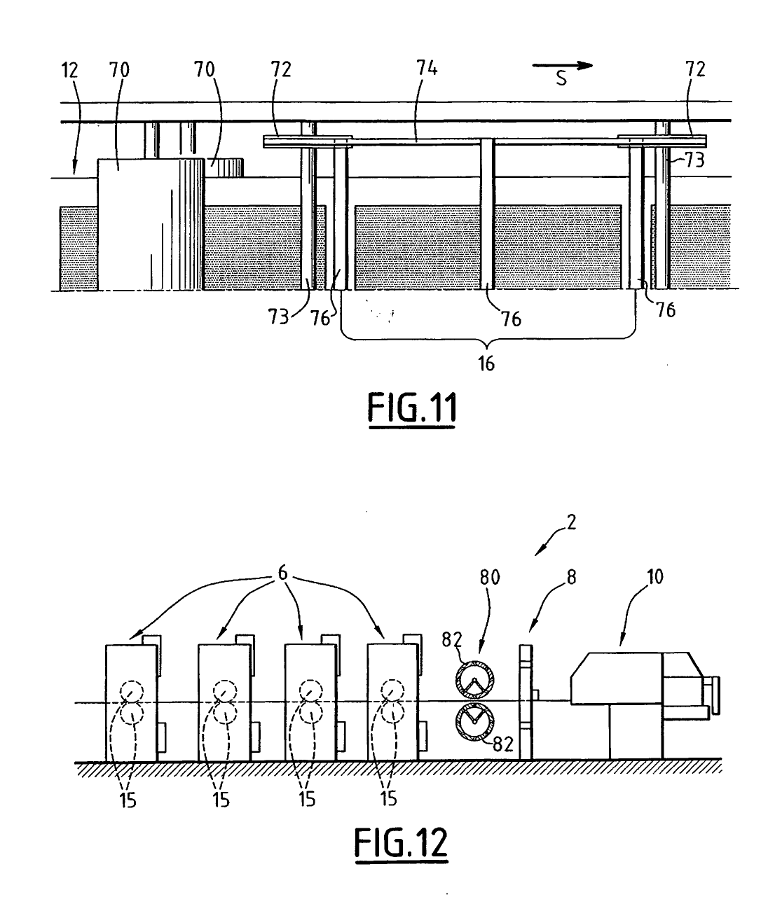

FIG. 12 illustrates a portion of a variant of a printing machine, including an accompaniment device 80 which is arranged between the printing unit 6 which is furthest downstream and the cutting device 10. In this instance, the accompaniment device 80 is arranged upstream of the traction device 8. This accompaniment device 80 includes two support rollers 82 which are arranged at one side and the other of the web 12.

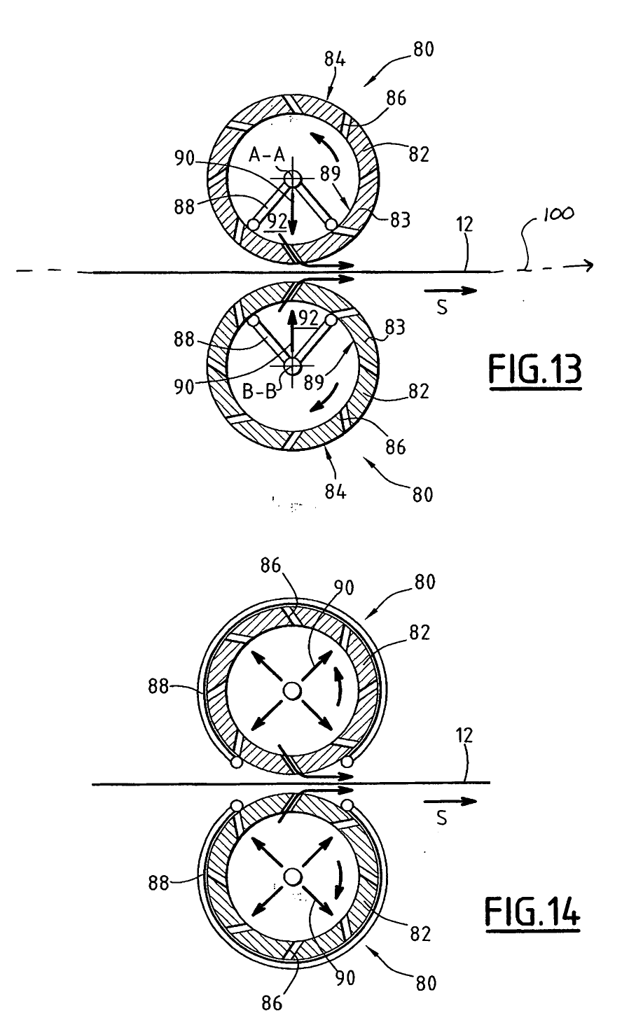

FIG. 13 is an enlarged cross-section of the support rollers 82.

The support rollers 82 are hollow and include a cylindrical wall 83 having an annular cross-section. The wall 83 forms an outer support surface 84. The accompaniment device 80 includes means for forming a cushion of air between the support surface 84 and the printed web 12. These means for forming a cushion of air include, at one side, openings 86 which extend through the wall 83 of the roller 82. These openings 86 are arranged, in cross-section, in a secant manner relative to the actual axis A-A, B-B of the roller 82. Furthermore, at the location close to the web 12, the openings 86 have a component which is directed in the movement direction S of the web 12, in a radially outward direction relative to the actual axis A-A, B-B of the roller 82 in question. Furthermore, the means for forming a cushion of air include two sealing walls 88 which are arranged at the inner side of each support roller 82, these walls 88 pressing, at one side, in an air-tight manner against the inner surface 89 of the wall 83 and, at the other side, at the center axis of the support roller 82. Furthermore, a pressurized air inlet 90 is connected to the chamber 92 defined by the walls 83 and 88.

During operation of this accompaniment device 80, the support rollers 82 are driven in terms of rotation in such a manner that their circumference at the location close to the printed web moves in the direction S of the path 100 of the printed web 12. The opening 86 which, at a given time, is in communication with the chamber 92 defined by the walls 83 and 88, allows the air in the chamber 92 to be discharged and allows a cushion of air to be formed between the outer surface 84 and the printed web 12, which guides the printed web 12.

FIG. 14 illustrates a variant of the accompaniment device 80 which differs from the device of FIG. 13 in the following manner. Similar elements have the same reference numerals.

This accompaniment device 80 includes, per roller 82, a single sealing wall 88 which extends around the support roller 82 over practically the entire circumference thereof, with the exception of a portion which is directed towards the printed web 12. No sealing wall extends at the inner side of the roller 82. This embodiment is simple to produce.

In a variant which is not illustrated, at least one of the traction rollers 20, 22 includes openings in the outer surface thereof, and the traction device 8 is provided with a pressure reduction device which is suitable for forming a reduced pressure in these openings. This helps to guide the web 12.

Generally, the traction elements include traction surfaces which come into contact only with the non-printed zone of the web 12. To this end, the traction elements may include a traction roller which presses on a lateral, non-printed zone of the web.

According to specific embodiments, the printing machine may include one or more of the following features.

The machine may be suitable for conveying the printed web in a state of free suspension and in ambient air over the entire path between the printing unit that is furthest downstream and the traction device.

The machine may be suitable for conveying the printed web in ambient air over the entire path between the traction device and the cutting device.

The machine may include a device for drying the printed web, in particular an infrared radiation drying device, arranged downstream of the traction device and upstream of the cutting device.

The traction device may include two traction elements, each having a traction surface which is suitable for coming into contact with a face of the printed web in order to apply the predetermined mechanical traction to this printed web.

The machine may include means for supplying a liquid, which means repel the ink onto at least one traction surface.

The two traction elements may include traction surfaces which repel the ink. The two traction elements may be traction rollers. The two traction rollers may be arranged in mutually spaced-apart manner, with a substantially S-shaped path being defined for the printed web.

The two traction rollers may be arranged one behind the other on the path of the printed web, and the traction device may include two clamping rollers, each of which is arranged facing one of the traction rollers, the clamping rollers having a diameter which is different from the diameter of the traction rollers, with a clamping roller and a traction roller being suitable in each case for clamping the printed web between them.

The two traction rollers may be arranged facing each other. Each of the two traction elements may be suitable for coming into contact with one of the two opposing faces of the printed web.

At least one of the traction rollers may include openings in the outer surface thereof, and the traction device may be provided with a pressure reduction device which is suitable for forming a reduced pressure in these openings.

The traction device may be provided with a device for cleaning the traction surface of at least one of the traction rollers. The cleaning device may include a cleaning bar which is in contact with the traction surface.

The cleaning device may include a first cleaning roller whose surface is suitable for coming into rolling contact with a traction roller, the surface of the first cleaning roller attracts the ink and the cleaning device may include means for removing the ink from the surface of the cleaning roller.

The cleaning roller may be moved between a cleaning position in which it is in contact with the associated traction roller and a washing position in which it is in contact with a device for washing the cleaning roller.

The cleaning device may include a second cleaning roller which is suitable for coming into contact with the same traction roller as the first cleaning roller, and these two cleaning rollers may be suitable for alternately coming into contact with the traction roller.

The traction rollers and the clamping rollers may be moved between a traction position of the printed web and a cleaning position, and the machine may be suitable for moving a pair including a traction roller and a clamping roller into the cleaning position thereof whilst the other pair including a traction roller and a clamping roller is in the traction position thereof.

The traction elements include traction bars which extend through the printed web. The machine further may include an accompaniment device which is arranged between the printing unit that is furthest downstream and the cutting device, this accompaniment device includes at least one support roller which is provided with a support surface for the printed web, and the accompaniment device includes means for forming a cushion of air between the support surface and the printed web.

What is claimed is:

1. A rotary printing machine comprising:
at least one printing unit for printing on a continuous printing web of material to be printed;
a cutting device for cutting the web printed by the printing unit; and
a traction device located on a path downstream of a furthest downstream printing unit of the at least one printing unit upstream of the cutting device, the traction device applying a predetermined mechanical tension to the printed web being discharged from the furthest downstream printing unit.

2. The printing machine as recited in claim 1 wherein the machine conveys the printed web in a state of free suspension and in ambient air over the entire path between the furthest downstream printing unit and the traction device.

3. The printing machine as recited in claim 1 wherein the machine conveys the printed web in ambient air over the entire path between the traction device and the cutting device.

4. The printing machine according to claim 1 wherein the machine includes a device for drying the printed web arranged downstream of the traction device and upstream of the cutting device.

5. The printing machine as recited in claim 4 wherein the device for drying is an infrared radiation drying device.

6. The printing machine as recited in claim 1 wherein the traction device includes first and second traction elements each having a traction surface coming into contact with a face of the printed web to apply a predetermined mechanical traction to the printed web.

7. The printing machine as recited in claim 6 wherein the machine includes a device for supplying a liquid, the liquid repelling an ink on the printed web.

8. The printing machine as recited in claim 6 wherein the first and second traction elements each have traction surfaces that repel ink.

9. The printing machine as recited claim 6 wherein the first and second traction elements are traction rollers.

10. The printing machine as recited in claim 9 wherein the first and second traction rollers are arranged in a mutually spaced-apart manner with a substantially S-shaped path defined for the printed web.

11. The printing machine as recited in claim 9 wherein the first traction roller is arranged behind the second traction roller on the path of the printed web and the traction device includes first and second clamping rollers, the first clamping roller arranged facing a first traction roller, the second clamping roller arranged facing a second traction roller, the first and second clamping rollers having a diameter different from a diameter of the first and second traction rollers, the printed web being clamped by the first or second clamping rollers and the first or second traction rollers.

12. The printing machine as recited in claim 9 wherein the first and second traction rollers are arranged facing each other.

13. The printing machine as recited in claim 6 wherein the first and second traction elements contact one of two opposing faces of the printed web.

14. The printing machine as recited in claim 9 the first or second traction roller includes openings in an outer surface thereof and the traction device includes a pressure reduction device forming a reduced pressure in the openings.

15. The printing machine as recited in claim 9 wherein the traction device includes a cleaning device for cleaning the traction surface of at least the first or second traction roller.

16. The printing machine as recited in claim 15 wherein the cleaning device includes a cleaning bar in contact with the traction surface of the first or second traction roller.

17. The printing machine as recited in claim 15 wherein the cleaning device includes a first cleaning roller having a surface that comes into rolling contact with the first or second traction roller; the surface of the first cleaning roller attracting the ink; the cleaning device removing the ink from the surface of the cleaning roller.

18. The printing machine as recited in claim 17 wherein the first cleaning roller moves between a cleaning position in contact with the first or second traction roller and a washing position in contact with a device for washing the cleaning roller.

19. The printing machine as recited in claim 17 wherein the cleaning device includes a second cleaning roller contacting a same first or second traction roller as the first cleaning roller, the first and second cleaning rollers alternately contacting the same first or second traction roller.

20. The printing machine as recited in claim 10 wherein the traction device includes a cleaning device for cleaning the traction surface of at least the first or second traction rollers, the first and second traction rollers and first and second clamping rollers moving between a traction position and a cleaning position of the printed web, the machine moving a first pair including the first traction roller and the first clamping roller into the cleaning position while a second pair including the second traction roller and the second clamping roller is in the traction position.

21. The printing machine as recited in claim 1 wherein the traction device includes traction bars contacting non-printed zones of the web.

22. The printing machine as recited in claim 1 further comprising an accompaniment device arranged between the furthest downstream printing unit and the cutting device, the accompaniment device having at least one support roller with a support surface for the printed web, the accompaniment device forming a cushion of air between the support surface and the printed web.

23. A printing method for printing comprising the steps of:
printing on a printing web forming a printed web;
cutting the printed web into printed sheets; and
producing a predetermined mechanical tension in the printed web before cutting using the printing machine as recited in claim 1.
